(19) United States
(12) Patent Application Publication
(10) Pub. No.: US 2005/0129008 A1
(43) Pub. Date: Jun. 16, 2005

(54) Congestion management apparatus, systems, and methods

(75) Inventors: Sachin Doshi, Bangalore (IN); Suryakant Maharana, Bangalore (IN); Praveen K. Subrahmanian, Bangalore (IN)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 10/737,995

(22) Filed: Dec. 16, 2003

(51) Int. Cl. H04L 12/56

(52) U.S. Cl. 370/389

(57) ABSTRACT

An apparatus and a system, as well as a method and article, may operate to send a packet from a first switch to a second switch by way of a stacked port, the packet identifying a congesting port included in the second switch as a source of congestion with respect to a congested port included in the first switch.

### TECHNICAL FIELD

Various embodiments described herein relate to data processing generally, including apparatus, systems, and methods used to transmit and receive information, such as data packets.

### BACKGROUND INFORMATION

Multiple data switches may be connected so as to provide a single switch having several ports, known as a “stacked switch.” In turn, stacked switches may be connected together using high-bandwidth ports called “stacked ports.” The large volume of traffic flowing from one stacked switch to another through interconnected stacked ports, comprising a multiplexed stream of data originating from several ports at the transmitting switch, may cause congestion in the receiving switch.

While a congested stacked switch can determine that congestion exists, no simple mechanism exists for relieving congestion. For example, sending flow control packets directly to the ports involved may stop traffic flow through intermediate stacked ports. Even sending a pause frame to ports in accordance with the Ethernet standard may affect traffic flowing to ports that are not congested. For more information regarding the Ethernet standard, please see the Institute of Electrical and Electronics Engineers (IEEE) 802.3, 2000 Edition, IEEE Standard for Information Technology—Telecommunications and information exchange between systems—local and metropolitan area networks—specific requirements—Part 3: Carrier Sense Multiple Access with Collision Detection Access Method and Physical Layer Specifications. Thus, various mechanisms to more efficiently manage port congestion are needed.

### BRIEF DESCRIPTION OF THE DRAWINGS

FIG. 1 is a block diagram of an apparatus and a system according to various embodiments;

FIG. 2 is a flow chart illustrating several methods according to various embodiments; and

FIG. 3 is a block diagram of an article according to various embodiments.

### DETAILED DESCRIPTION

To manage congestion as information flows between various points, including networked switches, the mechanisms proposed herein may operate to pass flow control information to a remote source of congestion without causing intermediate stacked ports to pause in their operations. Whenever congestion is detected at a congested port, a packet may be formed and sent to the source of congestion, perhaps by way of one or more intermediate stacked port. The packet may include information serving to pause or stop the remote source of congestion in its operation. However, using this scheme, stacked ports linking the remote source of congestion and the congested port (which may itself be a stacked port) may not have to pause or stop operations in order to alert the remote source of congestion to the existence of congestion.

When congestion is detected at a congested port, perhaps located in a switch supporting hardware stacking, the source of congestion may be determined by extracting information related to the original source of the packet from packets received at the switch experiencing congestion. Based on the extracted information, the switch may generate a special frame and/or packet carrying information sufficient to indicate the identity of the source of congestion (e.g., a congesting port included in a remote device, such as another switch). When the remote device receives the frame/packet, the congesting port may then be flow-controlled. Intermediate devices and/or ports (including stacked ports) examining the frame/packet are able to determine that the source of congestion is not local, and they can pass on the frame/packet until it reaches the source of congestion, where a pause frame can be initiated at the local port causing the congestion. In this manner information regarding congestion can be passed to the source of congestion without pausing intermediate stacked ports.

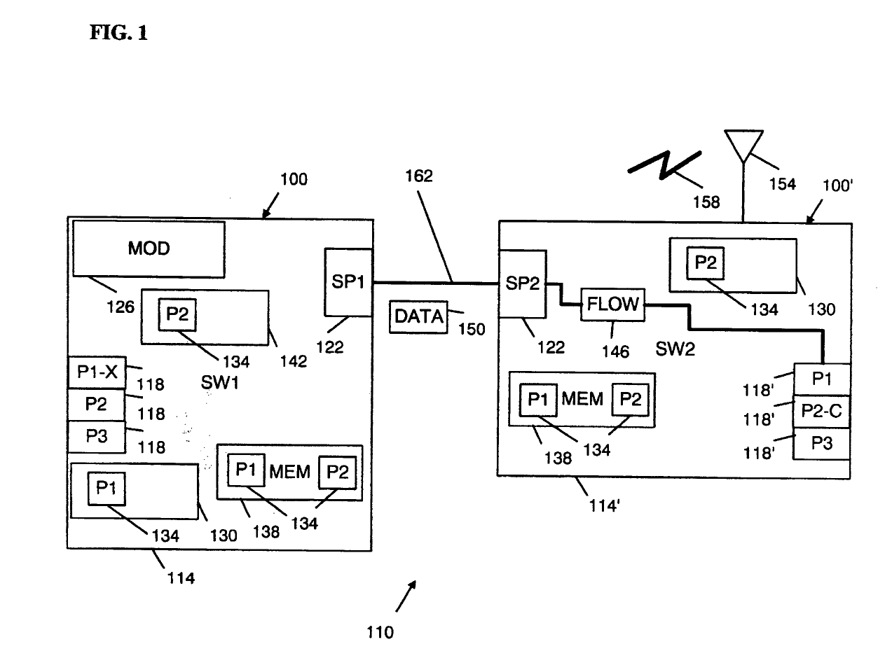

FIG. 1 is a block diagram of an apparatus 100 and a system 110 according to various embodiments, each of which may operate in the manner described above. For example, an apparatus 100 may comprise a first switch 114 including one or more non-stacked ports 118, and/or one or more stacked ports 122. The apparatus 100 may also include a module 126 to determine the identity of a congesting port 118′ (e.g., port P2-C) in a second switch 114′ as a source of congestion with respect to a congested port (e.g., port P1-X) in the first switch 114. The congested port may also be a stacked port 122 (e.g., SP1) in the switch 100. For the purposes of this document, the reader should keep in mind that the apparatus 100, 100′, the switches 114, 114′, and ports 118, 118′ may be similar or identical.

The apparatus 100 may include elements to alert other apparatus 100′ as to the source of congestion, such as a module 130 to form a first packet 134 (e.g., packet P1) identifying the congesting port P2-C, and a memory 138 to store the first packet 134. The apparatus 100, 100′ may also include elements to determine whether a source of congestion might be internal, perhaps receiving alerts from other apparatus 100′. Thus, in various embodiments, the apparatus 100, 100′ may also include a module 142 to examine a second packet 134 (e.g., packet P2), perhaps including an indication of one of the plurality of ports 118, 122 as a congesting port.

The apparatus 100, 100′ may include a module 146 to control a data flow 150 associated with the congesting port (which in the exemplary illustration of FIG. 1 may be any of the plurality of ports 118′, SP2, but is indicated for clarity as P2-C) responsive to receiving the packet P1, which may include an indication (e.g., an identification) of the congesting port P2-C. However, the stacked port SP1 for example, may receive the packet P1, and send it on to another switch 114′, without pausing in its operations.

In another embodiment, a system 110, which may comprise an apparatus 100 as described above, may also include a second switch 114′ to receive packets 134 from the first switch 114 (included in the apparatus 100), such as the packet P1, the second switch 114′ including a module 146 to control a data flow 150 associated with the congesting port, such as port P2-C. The system 110 may also comprise an antenna 154, such as an monopole, a dipole, a patch antenna, or an omnidirectional antenna to receive information 158 included in the data flow 150. In addition, the system 110 may comprise a communications medium 162 to couple the first switch 114 to the second switch 114′.

The apparatus 100, 100′, system 110, switches 114, 114′, ports 118, 118′ stacked ports 122, modules 126, 130, 142, 146, packets 134, memories 138, data flow 150, antenna 154, information 158, and communications medium 162 may all be characterized as “modules” herein. Such modules may include hardware circuitry, and/or one or more processors and/or memory circuits, software program modules, including objects and collections of objects, and/or firmware, and combinations thereof, as desired by the architect of the apparatus 100, 100′ and the system 110, and as appropriate for particular implementations of various embodiments.

It should also be understood that the apparatus and systems of various embodiments can be used in applications other than for data switches, and other than for systems that include a plurality of networked data switches, and thus, various embodiments are not to be so limited. The illustrations of apparatus 100, 100′ and systems 110 are intended to provide a general understanding of the structure of various embodiments, and they are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, processor modules, embedded processors, and application-specific modules, including multilayer, multi-chip modules. Such apparatus and systems may further be included as sub-components within a variety of electronic systems, such as televisions, cellular telephones, personal computers, workstations, radios, video players, vehicles, and others.

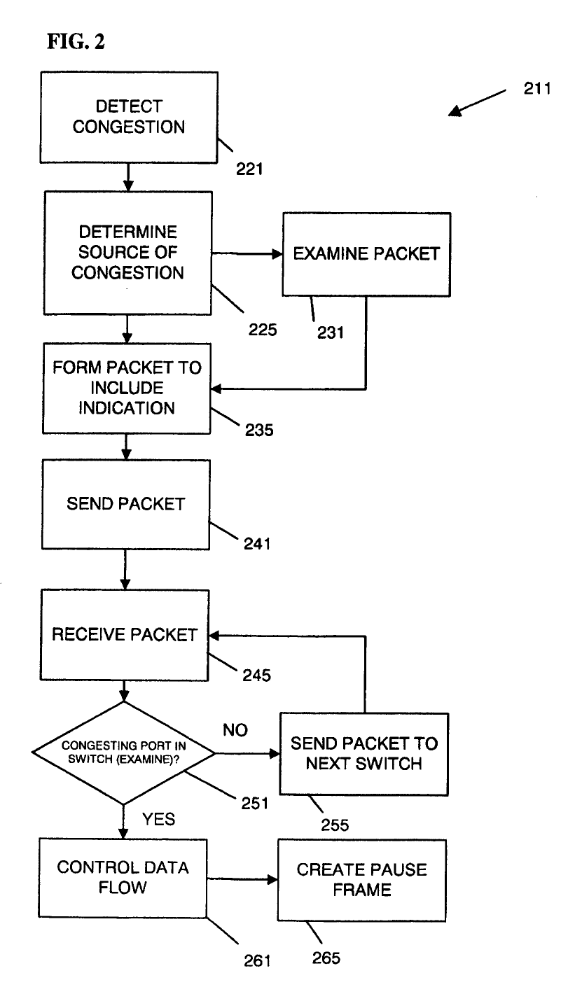

FIG. 2 is a flow chart illustrating several methods according to various embodiments. A method 211 may (optionally) begin with detecting the congestion at a congested port at block 221. The method 211 may then continue with determining the source of congestion at block 225, which may in turn include examining one or more packets directed to the congested port at block 231.

The method 211 may then continue at block 235 with forming a packet to include an indication (e.g., an identification) of the congesting port, and, at block 241, sending the packet from a first location to a second location (e.g., from a first switch to a second switch by way of a stacked port), wherein the packet identifies the congesting port included in the second location (e.g., a port in the second switch) as a source of congestion with respect to a congested port at the first location (e.g., a port included in the first switch). As noted above, the congested port may comprise a stacked port. In addition, the packet may be formatted according to the IEEE 802.3 standard.

The method 211 may include receiving the packet at a third location (e.g., a third switch) at block 245, and determining whether the congesting port is, or is not at the third location (e.g., included in the third switch). If it is determined at block 251 that the congesting port is not at the third location (e.g., included in the third switch), then the packet may be sent from the third location to another location (e.g., a second switch) at block 255.

If it is determined by, for example, examining the packet at block 251 that the congesting port is in the same location where the packet is received (e.g., the second switch), then, responsive to the second switch receiving the packet at block 245, the method 211 may include controlling a data flow associated with the congesting port at block 261. Controlling the data flow at block 261 may in turn include creating a pause frame within the second location (e.g., the second switch) at block 265.

It should be noted that the methods described herein do not have to be executed in the order described, or in any particular order. Moreover, various activities described with respect to the methods identified herein can be executed in serial or parallel fashion. For the purposes of this document, the terms “information” and “data” may be used interchangeably. Information, including parameters, commands, operands, and other data, can be sent and received in the form of one or more carrier waves.

Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. The programs may be structured in an object-orientated format using an object-oriented language such as Java, Smalltalk, or C++. Alternatively, the programs can be structured in a procedure-orientated format using a procedural language, such as assembly or C. The software components may communicate using any of a number of mechanisms well-known to those skilled in the art, such as application program interfaces or interprocess communication techniques, including remote procedure calls. The teachings of various embodiments are not limited to any particular programming language or environment, including Hypertext Markup Language (HTML) and Extensible Markup Language (XML).

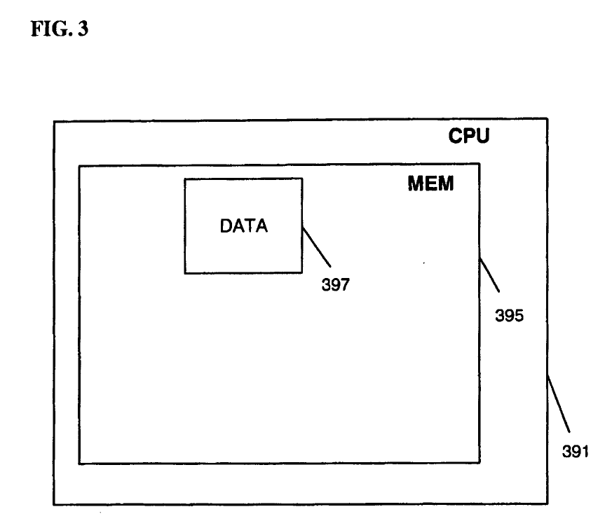

Thus, other embodiments may be realized. For example, FIG. 3 is a block diagram of an article 391 according to various embodiments, such as a computer, a switch, a memory system, a magnetic or optical disk, some other storage device, and/or any type of electronic device or system. The article 391 may comprise a machine-accessible medium such as a memory 395 (e.g., a memory including an electrical, optical, or electromagnetic conductor) having associated data 397 (e.g., computer program instructions), which, when accessed, results in a machine performing such actions as sending a packet from a first switch to a second switch by way of a stacked port. The packet may identify a congesting port included in the second switch as a source of congestion with respect to a congested port included in the first switch. Other actions may include receiving the packet from the first switch at a third switch, determining the congested port is not in the third switch (e.g., by examining the packet), and then sending the packet to the second switch.

Further activities may include controlling a data flow associated with the congesting port, responsive to the second switch receiving the packet. Controlling the data flow may include creating a pause frame within the second switch.

Implementing the apparatus, systems, and methods described herein may result in increased overall network switch performance, since intermediate stacked ports may not have to pause in their operations to accommodate congested conditions. In addition, the mechanisms disclosed herein can be built into many different types of stacking architecture, including switches supporting hardware stacking.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment.

1. A method, comprising:
sending a packet from a first switch to a second switch by way of a stacked port, the packet identifying a congesting port included in the second switch as a source of congestion with respect to a congested port included in the first switch.

2. The method of claim 1, further comprising:
detecting the congestion at the congested port.

3. The method of claim 1, further comprising:
determining the source of congestion.

4. The method of claim 3, wherein determining the source of congestion further comprises:
examining at least one packet directed to the congested port.

5. The method of claim 1, further comprising:
forming the packet to include an indication of the congesting port.

6. The method of claim 1, further comprising:
responsive to the second switch receiving the packet, controlling a data flow associated with the congesting port.

7. The method of claim 6, wherein controlling the data flow further comprises:
creating a pause frame within the second switch.

8. An article comprising a machine-accessible medium having associated first data, wherein the first data, when accessed, results in a machine performing:
sending a packet from a first switch to a second switch by way of a stacked port, the packet identifying a congesting port included in the second switch as a source of congestion with respect to a congested port included in the first switch.

9. The article of claim 8, wherein the first data, when accessed, results in the machine performing:
receiving the packet from the first switch at a third switch;
determining the congesting port is not in the third switch; and
sending the packet to the second switch.

10. The article of claim 9, wherein determining the congesting port is not in the third switch further comprises:
examining the packet.

11. The article of claim 8, wherein the first data, when accessed, results in the machine performing:
responsive to the second switch receiving the packet, controlling a second data flow associated with the congesting port.

12. The article of claim 11, wherein controlling the second data flow further comprises:
creating a pause frame within the second switch.

13. The article of claim 8, wherein the congested port comprises a stacked port.

14. The article of claim 8, wherein the packet is formatted according to an Institute of Electrical and Electronics Engineers 802.3 standard.

15. An apparatus, comprising:
a first switch including a first port; and
a module to form a packet identifying a congesting port in a second switch as a source of congestion with respect to the first port.

16. The apparatus of claim 15, further comprising:
a memory to store the packet.

17. The apparatus of claim 15, wherein the first port comprises a stacked port.

18. The apparatus of claim 15, further comprising:
a stacked port to receive the packet and to send the packet to the second switch.

19. A system, comprising:
a first switch including a first port;
a module to form a packet identifying a congesting port as a source of congestion with respect to the first port; and
a second switch to receive the packet, the second switch including a module to control a data flow associated with the congesting port.

20. The system of claim 19, further comprising:
an omnidirectional antenna to receive information included in the data flow.

21. The system of claim 19, further comprising:
a memory to store the packet.

22. The system of claim 19, further comprising:
a communications medium to couple the first switch to the second switch.

23. The system of claim 19, wherein the first port comprises a stacked port.

24. An apparatus, comprising:
a first switch including a stacked port;
a module to determine a congesting port in a second switch as a source of congestion with respect to the stacked port;
a module to form a first packet identifying the congesting port; and
a memory to store the first packet.

25. The apparatus of claim 24, further comprising:
a module to examine a second packet including an indication of the stacked port as a congesting port.

26. The apparatus of claim 24, further comprising:
a module to control a data flow associated with the stacked port responsive to receiving the second packet.
